(19) United States
(12) Patent Application Publication
(10) Pub. No.: US 2009/0119157 A1
(43) Pub. Date: May 7, 2009

(54) SYSTEMS AND METHOD OF DERIVING A SENTIMENT RELATING TO A BRAND

(75) Inventor: Rajiv Dulepet, West Hills, CA (US)

Correspondence Address: FISH & ASSOCIATES, PC;ROBERT D. FISH, 2603 Main Street, Suite 1000, Irvine, CA, 92614-6232, US

(73) Assignee: WISE WINDOW INC., Santa Monica, CA (US)

(21) Appl. No.: 12/253,567

(22) Filed: Oct. 17, 2008

Related U.S. Application Data
(60) Provisional application No. 60/985,081, filed on Nov. 2, 2007.

(51) Int. Cl. G06Q 10/00; G06F 17/30

(52) U.S. Cl. 705/10; 707/103 R; 707/E17.045

(57) ABSTRACT

Methods for deriving a brand sentiment are presented. Phrases and ratings associated with the brand are stored in a database. The phrases are analyzed and compared to each other and to the ratings to derive a statistical significance of a phrase usage relative to other phrases. A sentiment score is derive from the statistical significance.

This application claims the benefit of priority to U.S. provisional application having Ser. No. 60/985,081, filed on Nov. 2, 2007. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is market analysis.

### BACKGROUND

Companies conduct market research to understand how their brands are received by a target market. However, market researches find it difficult to find real-time buzz information associated with their brand or sentiment that consumers have for researcher's brand of interest.

Several companies attempt to provide real-time analysis tools for researching market buzz or sentiment information by scouring web sites; looking for relevant information. Example existing companies offering such services include Umbria®, Nielsen BuzzMetrics®, BuzzLogic®, TNS Cymfony, and Motive Quest. These and other services require a user to define initial search parameters to begin crawling the Web for buzz or sentiment. Unfortunately, such an approach forces the resulting data to conform to the researches pre-conceived notions of the buzz or the sentiment that they expect, thereby rendering the data skewed, or worse, useless. For example, a researcher could elect to search for sentiment associated with their product described by the term “great” and find many web sites that stating their product is “great”. However, they would likely miss other references that have terms that are not commonly associated with “great” including “superlative,” “phat,” “GR8” (“GR8” is short hand for “great” in text messaging, instant messaging, or other real-time communications) or other potential synonyms. Thus, the resulting data set is skewed and does not properly reflect the sentiment associated with their product.

Ideally a market research solution would review documents learn about the brand characteristics including quality, ratings, or products and then extract information associated with the brand for analysis without allowing a researcher to shape the data even before conducting an analysis. The extracted information would then be unbiased and used to gather buzz or sentiment statistics across numerous other documents.

Thus, there is still a need for providing market analytics where sentiment can be extracted in an unbiased manner from brand characteristics and stored in a database for analysis by a researcher.

### SUMMARY OF THE INVENTION

The present invention provides apparatus, systems and methods in which sentiment is derived from web documents.

In one embodiment, sentiment is derived by searching web documents for brand characteristics including phrases and ratings associated with brand entities. The characteristics are stored in a database and compared against each other to derive as statistical significance related to the usage of the phrase as it relates to the entity and to the ratings. A sentiment score is then derived from the statistical significance.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic of a graphical tag cloud displaying over developed and under developed positives and negatives.

FIG. 2 is a schematic of a graphical bubble chart comparing attributes with respect to their relative statistical significances.

FIG. 3 is a schematic of a trend chart using sentiment of various products as a function of time.

FIG. 4 is a schematic of graphical tag cloud showing an issue map using confidence levels.

FIG. 5 is a schematic of a horizontal bar chart showing the buzz of several terms using relative statistical significances.

FIG. 6 is a schematic of a method for deriving a sentiment.

### DETAILED DESCRIPTION

Market researchers use marketing analytics to research how people perceive their brand within the market. Two areas of interest to researchers when researching a brand include the buzz surrounding the brand and the sentiment that the market has toward the brand.

Within the context of this document, the term “brand” means a trademark or service mark, whether registered or not. In some cases a brand could be the name or image of a person, but not a person per se. As used herein “brand entity” represents a specific item relating to the brand that can be searched for. For example, a brand entity can include a company name, product, product feature, or other reference. In a preferred embodiment, a brand entity is represented by a digital data, possibly including a key word, an image, a sound, or other data that can be used to electronically search or analyze web-based documents.

The term “buzz” means the quantity of references associated with a target brand entity of interest. Buzz can be measured through the use of analysis tools indicate of how the buzz is affected by factors including time, geography, demographics, events, applied marketing effort, competitors, news, or other factors that can influence buzz. In some embodiments, buzz includes a rate, a relative value, a buzz density, or other measurement derived from the quantity of references. Researchers find buzz useful when attempting to detect the impact of marketing efforts on their brand.

The term “sentiment” means the general perception held by the market toward the brand. Sentiment can represent a full spectrum of perceptions from deeply negative to deeply positive. For example, the buzz surrounding a target brand entity could indicate a generally positive sentiment while the buzz surrounding a second target brand entity could indicate a generally negative sentiment. In a preferred embodiment, sentiment comprises a score that could be an absolute value or relative value. An absolute sentiment value can simply be a number on a scale. A relative sentiment value represents the difference between the sentiments of two target entities.

Before a researcher can begin researching the buzz or the sentiment related to their target brand entity, the researcher requires access to a data set, preferably a database, having compiled sentiment, entity, or attribute information. In a preferred embodiment, the database is compiled by crawling web documents and extracting the desired information from the documents.

Web documents include any document that can be accessed via a search program. Example web documents include text documents, images, pod-casts, videos, audio files, programs, instant messages, text messages, or other electronic documents. Preferred web documents are opinion-based documents including reviews, blogs, forum posts, or other documents where opinions are cited.

In the preferred embodiment, a search program crawls through web documents to compile buzz or sentiment data. The search program learns about a target brand entity by analyzing a first set of documents to understand how the target brand entity is referenced in the market in general. Preferably, the search program identifies documents having three brand characteristics including an entity characteristic, a quality characteristic, or a quantity characteristic. These and other characteristics are typically represented by words, phrases, numbers, or other analyzable quanta.

An entity characteristic includes data associated with the target brand entity having direct references to the target brand entity or an indirect reference to the target brand entity. A direct reference represents a match between literal strings, keywords, terms, or other tags. Indirect references are those references that are inferred from analyzing the web documents. For example, when crawling through web documents for “TV” the search program infers that references to “boob tube” or “monitor” indirectly refers to “TV”. Additionally, an entity characteristic can include attributes associated with the target brand entity. To continue the TV example, attributes could include “contrast”, “brightness”, “resolution”, or “cable-ready”. A search program automatically sifts through the information in the web documents to correlate any entity characteristic with the target brand entity. Since the search program is free from an initial bias it freely discovers additional statically relevant entity characteristic phrases that might not have been discovered otherwise. For example, the program can discover that an abbreviation, an acronym, other phrases, or other entity characteristic strongly correlates with the target brand entity. The correlation can be done through building statistics around the number of occurrences that an entity characteristic is encountered within the web documents. The entity characteristic provides a foundation for determining the buzz associated with a brand.

A quality characteristic represents a foundational element for sentiment and includes information about the perception of a target brand entity as indicated by the web documents. Quality characteristics include words, phrases, or other indications that the perception is positive or negative. The quality characteristics are generally human understandable, but not necessarily computer understandable. To illustrate this point consider the previous TV example. A first web document could contain a reference to the TV stating the “TV has a great picture.” In this example, “great” represents a positive quality characteristic, but does not necessarily equate to a quantifiable value to a computer. “Great” could also be used in a negative manner as in “this TV is a great waste of time”. Although quality characteristics do not necessarily provide a quantifiable reference by themselves, they can form the basis of a quantifiable sentiment when combined with quantity characteristics. Preferably a search program analyzes the web document to determine which words, phrases, or combination of references correlate to quality characteristics.

A quantity characteristic includes information that can be quantified by a computer program. Typical quantity characteristics found within web documents include ratings, number of citations, or other indication of a value. Some quality characteristics are inferred from information within the web documents where a subjective scale is presented. Consider web documents that list a spectrum of information from “Strongly disagree” to “Strongly agree” with eight steps between the two. Such a scale can be contextually reduced to a value or number; one through 10 in this case. Other quantity characteristics are simply references to a number; a number of stars associated with a movie rating for example.

In a preferred embodiment, the search program starts with a first set of web documents to convert the quality, quantity, and entity characteristics to extracted information associated with the target brand entity or brand. The various characteristics are compared against each, preferably using a form of regression analysis, to determine which combinations of the characteristics have strong correlations. Buzz statistics are created based on the number of references to entities or attributes. Sentiment information is derived by equating the quality characteristics with the quantity characterizes within the same web documents. When the analysis has proceeded sufficiently, the search program then has an understanding for which entities to search in additional web documents, and how to derive sentiment from the additional documents. In the preferred embodiment, the search program begins with review documents that have all three characteristics to form an understanding of the brand information. Then additional web documents are searched to compile additional statistics and to learn more about the brand.

Information extracted from web documents includes entity references, attributes, or sentiment. As previously mentioned, entity references represent how web documents refer to the target brand entity can include the brand, a person, a company, a product, a place, or event a service. Attributes include items associated with the entity and can include features, capabilities, limitations, advantages, disadvantages, or other associated information. The resulting extracted information is stored in a database for retrieval and analysis.

In a preferred embodiment, sentiment is derived from the quality and quantity characteristics. Phrases from the web documents are stored in the database where the phrases are associated with the various brand characteristics. A program compares the phrases against each other and compares the phrases with the ratings found from the corresponding web documents, preferably by applying any of the following techniques: regression analysis, linear programming, hypothesis analysis, clustering, or dynamic programming. The program tracks the usage pattern of the phrases to derive a statistical significance of the phrase usage relative to the various entities. The program also makes inferences from the phrases to a broad set of phrases thereby establishing a phrase-base scaling of sentiments. A sentiment score is then derived from a function of the relative statistical significance. Although the sentiment score preferably has a value on a numeric scale, other scale are also contemplated including thumbs up, hot-or-not, opinion (“good”, “OK”, or “bad”), or other scales other than numeric.

An example will provide further clarity of how sentiment is derived. Suppose a researcher wishes to compare sentiment between TV and radio, both of which represent entities. The database comprises the raw data that includes phrases associated with the brand characteristics (quality, quantity, and entity data). The program compares how each of the phrases is used with respect to the entities and the ratings. For example, the phrase “great” could be referenced 100 times for TV indicating that the term “great” might have a strong statistical significance of a positive sentiment. For radio, “great” might be referenced only ten times possibly indicating a weak statistical significance that the sentiment is positive. In this example, “great” has a relative statistical significance of a factor of ten for TV over radio. A sentiment score can then be assigned to “TV” as a function of the relative statistical significance. In this simple example, the function is simply the relative statistical significance itself without alteration resulting in a sentiment score of 10 for TV. In the preferred embodiment, sentiments are derived by normalizing the various values using well-know techniques including Z-Statistics to facilitate the comparison. All functions for calculating sentiment are contemplated including those where a researcher refines how sentiment is derived.

The database stores brand characteristics and associated phrases or ratings in a structured format. In a preferred embodiment, information is stored hierarchically to assist in analyzing data. For example, entity information could be stored in a hierarchy where a company name is the top of the hierarchy followed by the tree comprising product type, product name, product model, and product features. It is also contemplated that the database supports many-to-many relationships among all the entries.

One skilled in databases will recognize that exploring various combinations of the phases associated with brand characteristics can result in an extremely large number of entries in the database. In the preferred embodiment, the database is cleansed by removing entries that have a corresponding relative statistical significance that falls below a threshold value or are excluded as a result of other functions of relative statistical significance.

It is contemplated that additional information is also stored in the database for use in analysis. Typical information includes date or time stamps, links to the web documents, authors, document types, citations, trustworthiness of the web documents, or other data associated with the web documents. It is also contemplated, that a researcher could specifically request specific additional types of data to be retained during the search.

As the search program continues its search for additional information, it crawls through a large number of web documents to build statistics associated with the information. As the search continues the program preferable weights documents having the quality, quantity, and entity characteristics, however, it is not necessary to restrict the search to only those documents. In alternative embodiments the program also searches web documents having one or two of the characteristics, and in some cases, none of the three characteristics. Documents lacking brand characteristics are useful to establish a background comparison of brand information and can be used to indicate lack of buzz penetration into a marketing domain.

In some situations where data is readily available the information is obtained quickly in a matter of hours, minutes, or even seconds and the real-time information is supplied to the researcher. In other situations where information is not readily available, the information could be aggregated over days, weeks, or even months. In either case, the data is preferrably provided to a researcher immediately upon availability even if a desired level of statistics has yet to be reached.

The preferred embodiment uses the collected information to derive a statistical significance associated with the brand information. The statistical significance includes a measure of the number of references of the information in the database where the significance can be an absolute value or a relative value. Absolute values are those significances having a raw number, 1 million references for example, and can be used to sort or rank occurrences of the extracted information. Relative values can be measured relative to a background or to other entries in the database. A background measure, similar to a density, indicates a number of “hits” in web documents relative to the total number of web documents searched and are useful when determining the penetration of buzz in various marketing domains. Relative statistical significances are useful when conducting competitive analysis or other research comparing brands.

In preferred embodiments software programs also derive relationships among the various entities, attributes, sentiments or other extracted information in the database as a function of the data collected by the search program. Preferred types of relationships include trends, relative statistical significances of buzz, sentiment, and attributes, over or underdeveloped positives and negatives, or confidence levels. Relationships are preferably presented to a researcher in a graphical form including a tag cloud, trend graph, bar chart or other form. In especially preferred embodiments a researcher can construct a desired graphical representation of the relationships.

The following figures illustrate possible embodiments of graphical representations of relative significances of various entities, relationships, and attributed derived from extracted information.

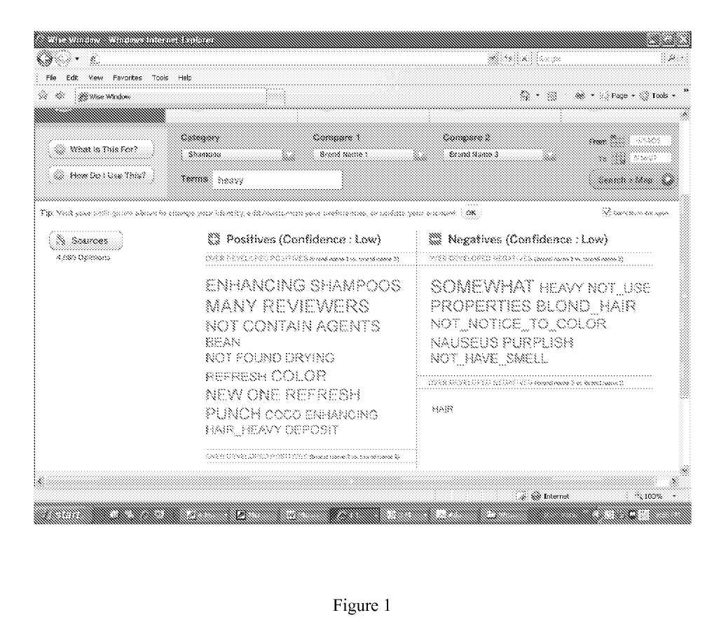

FIG. 1 is a schematic of a graphical tag cloud displaying over developed and under developed positives and negatives.

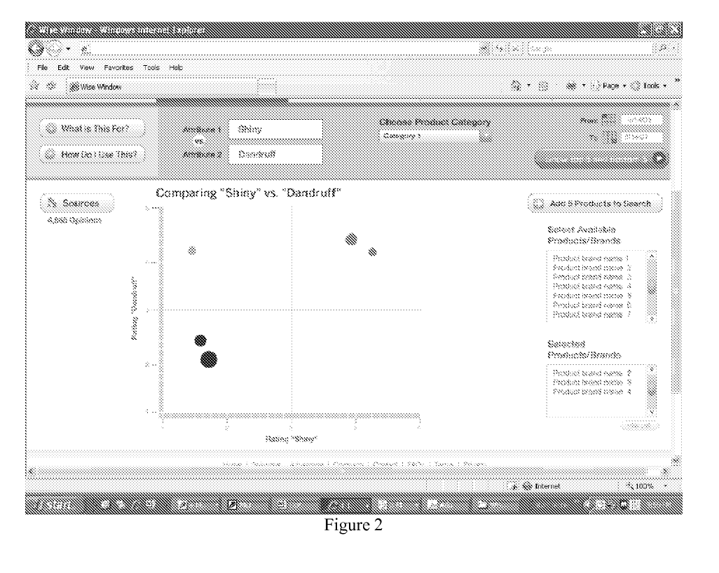

FIG. 2 is a schematic of a graphical bubble chart comparing attributes with respect to their relative statistical significances.

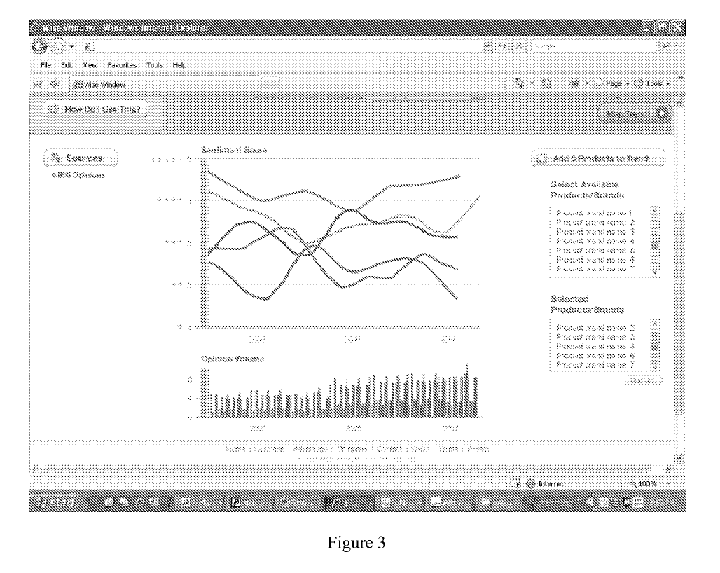

FIG. 3 is a schematic of a trend chart using sentiment of various products as a function of time.

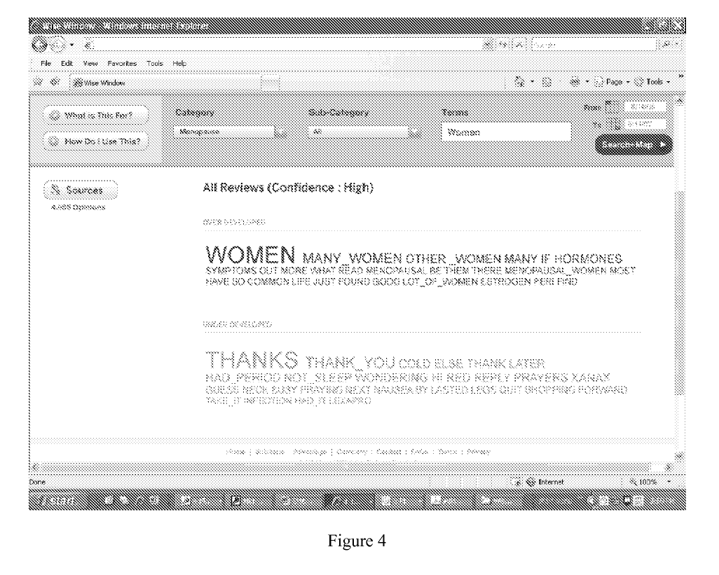

FIG. 4 is a schematic of graphical tag cloud showing an issue map using confidence levels.

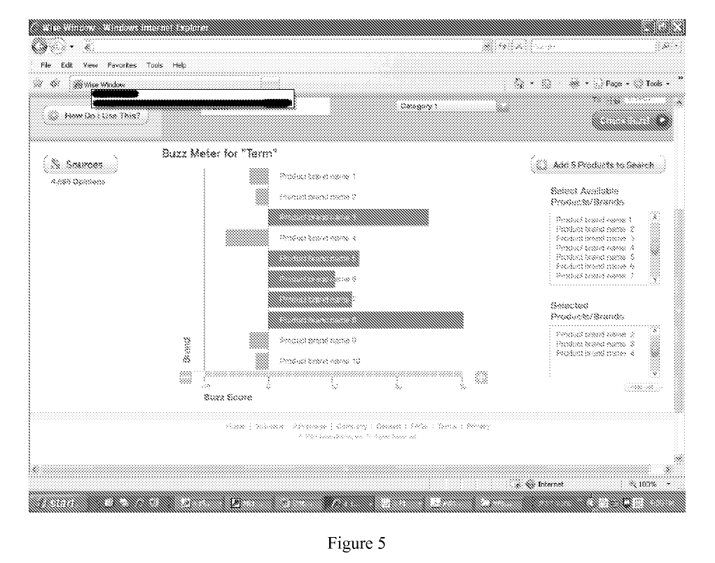

FIG. 5 is a schematic of a horizontal bar chart showing the buzz of several terms using relative statistical significances.

Researchers use one more provided analysis tools to map the buzz or the sentiment in a marketing domain using a desired format. As previously stated, graphical tools are one form of analysis tools. In addition, non graphical tools are also contemplated including spreadsheets, script engines, or other systems that provide for analyzing the data.

The preferred embodiment also provides for accessing raw data directly. As a researcher analyzes their data set, they are able to request a link to where the resulting information comes from and gain access to the derivation of sentiment, brand characteristics, or even the original web documents.

One should appreciate the advantages provided by the outlined approach. A researcher can analyze buzz or sentiment associated with any market including product marketing, movie reviews, personal presence (movie stars for example), or political campaigns.

Additionally, the data collected is generic with respect to the source material domain without being skewed by the researcher. A researcher will find that blogs will discuss a product differently than a technical review. The outlined approach will ensure each such domain is treated independently or internally consistent without bias while maintaining coverage across the markets. By treating each domain independently, the relative statistical significances or sentiments are domain specific ensuring the researcher obtains data without bias. For example, movie review sites might have positive sentiment about a movie while blogs have negative sentiment toward the movie, but both domain sources contribute to the buzz. Also, in both sources of information and their corresponding data are valuable to the researcher.

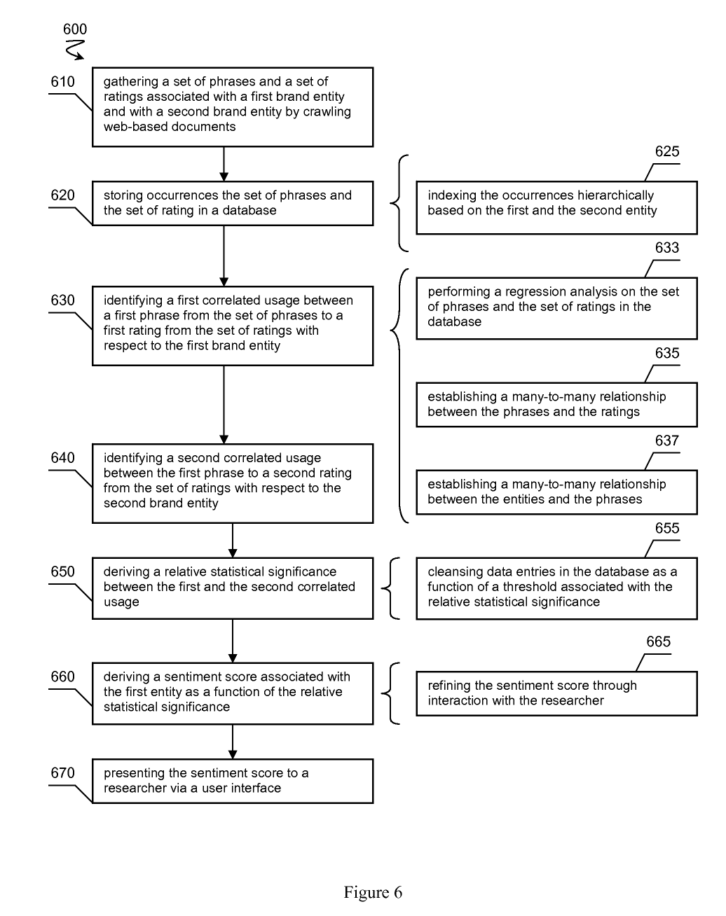

FIG. 6 presents method 600 for deriving a brand sentiment. Method 600 is preferably implemented through a computer system having software instructions stored on a computer readable media. Preferred computer system offer a researcher access to a database storing sentiment data via a user interface and effectively runs as a sentiment analysis engine.

At step 610, the computer system crawls through web documents accessible over the Internet to gather phrases and ratings associated with one or more identified brand entities. For example, a researcher might wish to compare brand entities, possibly “soda” or “wine”. The computer system collects phrases used within the web documents that references “soda” and “wine” and any ratings that appear within the documents. The researcher can represent the brand identity to the analysis engine as a key word, an image, a sound, or other data that can be represented digitally.

In a preferred embodiment, at step 620 any occurrences of the phrases and ratings are stored in a database of the computer system. It is contemplated that the stored occurrences can also include additional data pertaining the occurrences (e.g., metadata), possibly authors, time stamps, URLs, or other data. In circumstances where a researcher wishes to analyze a brand for a company relative to the company's products, at step 625, the occurrences can be stored in a hierarchal fashion based on the brand entities searched.

At step 630, a first correlation between the usage of a phrase and a rating is identified with respect to a first brand entity. The correlation can be determined through one of many suitable methods as previously discussed, including performing a regression analysis at step 633 on the phrases and ratings in the database. Various relationships between the elements stored in the database can be established. For example, a many-to-many relationship can be established between the various brand entities and the phrases found in the web documents at step 635. Additionally, a many-to-many relationship can be established between the phrases and ratings at step 637. Establishing such relationships allows a researcher to view the data from different perspectives or to filter the data to refine a sentiment score as they conduct their analysis.

Similar to step 630, at step 640 a second correlation between the usage of the phrase and a second rating is identified with respect to a second brand entity. Providing a second correlated usage allows the system or the researcher to conduct a comparison between the sentiments of brand entities. It should be noted that steps 633, 635, and 637 can also be conducted as part of step 640.

In a preferred embodiment, statistics are accumulated in the database for the phrase, ratings, brand entities, or the correlated usages. For example, at step 650 the statistics are used to derive a relative statistical significance between the correlated usages of the brand entities. Given that the number of entries in the database can become quite large where most of the entries are of low relevance, it is contemplated that the database can be cleansed at step 655 as a function of the relative statistical significance. For example, a researcher might wish to compare brand entities “soda” and “wine” which could results in a massive number of entries in the database. The researcher can instruct the system to remove entries in the database having a relative significance less than a specified value because such entries are deemed irrelevant.

At step 660 the relative statistical significance can be used to derive a sentiment score for a brand entity. As previously discussed the sentiment score can take on many forms, preferably a numerical value. The above outlined approach allows a researcher to analyze and track sentiment over time.

At step 670 the sentiment score can be presented to the researcher through a user interface including web pages as shown in FIGS. 1 through 5. In some embodiments, the user interface comprises a web accessible API (e.g., a web service) that can be programmatically accessed via software running local to the researcher, but remote relative to the sentiment analysis engine. In an especially preferred embodiment, at step 665, the researcher can interact with one or more provided analysis tools to refine the sentiment score by applying appropriate filters to the data in the database.

One skilled in the art should appreciate that the techniques disclosed are not limited to marketing analytics, but can also be applied to other areas where analytics are useful. For example, a heath care clinic could use the techniques to data mine their patient databases for interesting correlations between patients, among doctors, treated diseases for medical information.

It should be also apparent the data sources are not restricted only to web documents, but also any database source where quantity and quality information can be correlated. Other example database sources beyond web documents include customer support databases, or focus group results. An example use-case of non-web documents includes a product marketing researcher using sentiment derived from customer feedback data and correlating that sentiment to a database having returned product information.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of deriving a sentiment relating to a brand, the method comprising:
gathering a set of phrases and a set of ratings associated with a first brand entity and with a second brand entity by crawling web-based documents;
storing occurrences the set of phrases and the set of rating in a database;
identifying a first correlated usage between a first phrase from the set of phrases to a first rating from the set of ratings with respect to the first brand entity;
identifying a second correlated usage between the first phrase to a second rating from the set of ratings with respect to the second brand entity;
deriving a relative statistical significance between the first and the second correlated usage;
deriving a sentiment score associated with the first entity as a function of the relative statistical significance; and
presenting the sentiment score to a researcher via a user interface.

2. The method of claim 1, wherein the step of storing occurrences includes indexing the occurrences hierarchically based on the first and the second entity.

3. The method of claim 1, further comprising establishing a many-to-many relationship between the first and the second entity and phrases.

4. The method of claim 1, further comprising establishing a many-to-many relationship between the phrases and the ratings.

5. The method of claim 1, further comprising cleansing data entries in the database as a function of a threshold associated with the relative statistical significance.

6. The method of claim 1, wherein the first entity is selected from the group consisting of a company, a person, a product, the brand, a place, and a service.

7. The method of claim 1, wherein the relative statistical significance is domain specific.

8. The method of claim 1, wherein the sentiment is domain specific.

9. The method of claim 1, wherein the step of deriving a sentiment score includes refining the sentiment score through interaction with the researcher.

10. The method of claim 1, wherein the step of deriving a sentiment score includes performing a regression analysis on the set of phrases and the set of ratings in the database.

11. The method of claim 1, wherein the first phrase is selected from the group consisting of an acronym, and an abbreviation.

12. The method of claim 1, wherein the first brand entity is represented by an image.

13. The method of claim 1, wherein the first brand entity is represented by a sound.
